(19) United States
(12) Patent Application Publication
(10) Pub. No.: US 2005/0132353 A1
(43) Pub. Date: Jun. 16, 2005

(54) Method for installing networked attached storage

(76) Inventor: Chueh-Hsin Chen, Taipei (TW)

Correspondence Address: CHUEH-HSIN CHEN, P.O. BOX 26-757, TAIPEI, 106, TW

(21) Appl. No.: 10/736,028

(22) Filed: Dec. 11, 2003

(51) Int. Cl. G06F 9/445

(52) U.S. Cl. 717/174

(57) ABSTRACT

A method for installing networked attached storage. The networked attached storage is connected to a network with a plurality of storage. In the method, a first and a second storage carriers are connected to a first and second storage devices respectively, and a system medium built-in operating system is set in a remote server of the network. Afterward, the operating system is loaded to the first storage carrier, and then the operating system is mirrored to the second storage carrier. Finally, the operating system is mirrored to the third and forth storage devices for installing the operating system with the network on the hard disk-free networked attached storage (NAS).

### BACKGROUND OF THE INVENTION

1. Field of the Invention

The present invention relates to a method for installing a networked attached storage (NAS), and particularly, to a method for installing a hard disk-free networked attached storage.

2. Description of the Prior Art

Nowadays, local area networks are so popular that enterprises generally use a local area network to access internal data. Based on related research, it is reported that some of the files and data in the internal computers of the enterprises are repeatedly used, and therefore, the amount of repeatedly used files and data transmitted between the computers has to be decreased so as to reduce the load of server computer.

To solve this problem, a networked attached storage (NAS) is proposed to interconnect a plurality of computers through local area network (LAN). Therefore, the computers in a company can access files and data in the NAS through LAN. The NAS also provides file sharing for the client end and server end of different platforms and systems.

NAS is an IP-based data storage used in an Ethernet. Moreover, NAS uses a special data server to manage data flow in a LAN to communicate with different servers and workstations.

Because the NAS data server manages data access commands, other servers focus on processing instructions other than data accessing instructions.

As can be seen from above description, the NAS is characterized by distribution of storage space over different servers or workstations to provide data sharing through the network. The prior art NAS must add a fixed hard disk (FHD) when exporting, and the FHD must be installed with the file server operating system (OS) for the NAS.

However, the FHD maybe broken due to impact, unusual temperatures and humidity during transport. The NAS must collocate with the FHD of different products and capacities due to different business plan, with the result that the traditional NAS must spend a long time on operating system (OS) installation and hard disk testing. It is also inconvenient to return the NAS to the original manufacturer for repairs when the operating system (OS) inside the FHD is broken.

Therefore the inventor of the present invention intends to solve the inconveniences and faults of the FHD of the above NAS by disclosing a method for installing a hard disk-free networked attached storage (NAS).

The method installs NAS operating system in a hard disk-free NAS through a network. Therefore, no hard disk is installed in NAS during shipment.

### SUMMARY OF THE INVENTION

The object of the present invention is to provide a method for installing a networked attached storage, in which a hard disk-free is not required to solve the inconveniences and the faults resulting from a conventional FHD.

For the above intention, the major technological feature of the present invention is the method for installing the operating system in the networked attached storage in a network. The networked attached storage comprises a first, a second, a third and a forth storage devices. In the method, a first and a second storage carriers are connected to the first and the second storage devices. Moreover, the system medium comprises a built-in operating system in the remote server connected to the network. After the operating system is loaded into the first storage carrier, the operating system is mirrored by the second storage carrier. Finally, the operating system is mirrored by the system area of the third and forth storage devices for installation of the operating system with network on the hard disk-free networked attached storage (NAS).

It is another feature of the present invention to provide the method of the installing above, in which the first storage carrier can be removed after mirroring the operating system to the second storage carrier so as to be a spare fixed hard disk (FHD). Moreover, the second storage carrier functions as the first storage device, and a third storage carrier functions as the second storage device. Similarly the operating system of the first storage device is mirrored to the second storage device to serve as a fixed hard disk (FHD) of a spare system.

It is still another feature of the present invention to provide the above method of installation, in which the storage device is even in number and can be set as a redundant array of independent disks (RAID) to enhance the storage capability by paralleling storage or to increase the security and the fault tolerance by mirroring storage. Moreover, the present invention can be of a RAID LEVEL 5 format by dispersing the parity in some or all storage devices.

### BRIEF DESCRIPTION OF THE DRAWING

The various objects and advantages of the present invention will be more readily understood from the following detailed description when read in conjunction with the appended drawing, in which:

FIG. 1 is a block diagram of the networked attached storage (NAS) of the present invention;

FIGS. 2A-B are a flowchart of the method of the installing of the present invention;

FIG. 3 is a schematic diagram of the paralleling storage of a RAID;

FIG. 4 is a schematic diagram of the mirroring storage of a RAID.

### DETAILED DESCRIPTION OF THE PREFERRED EMBODIMENT

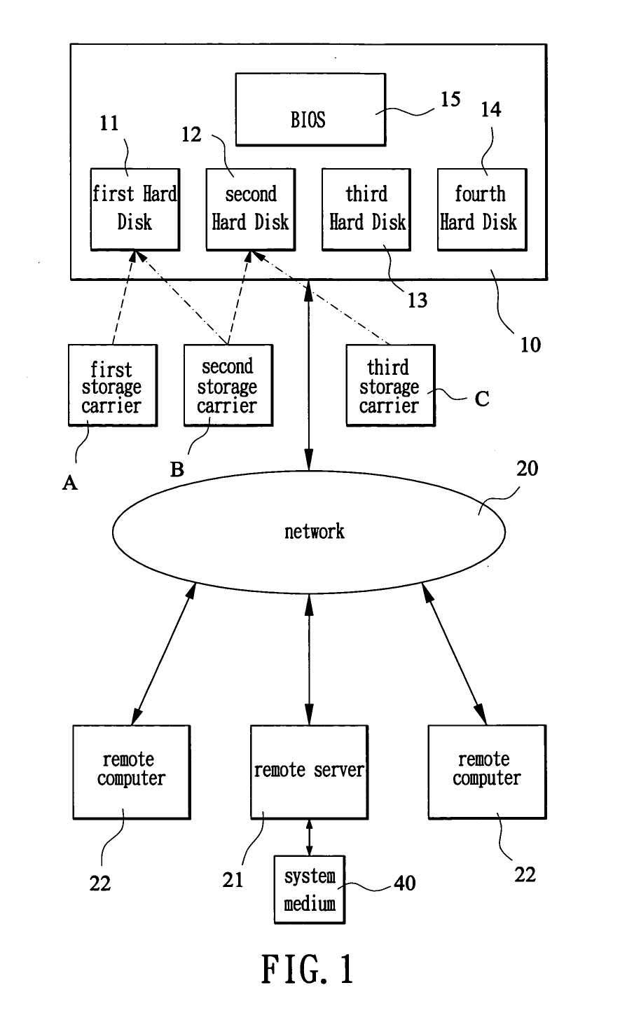

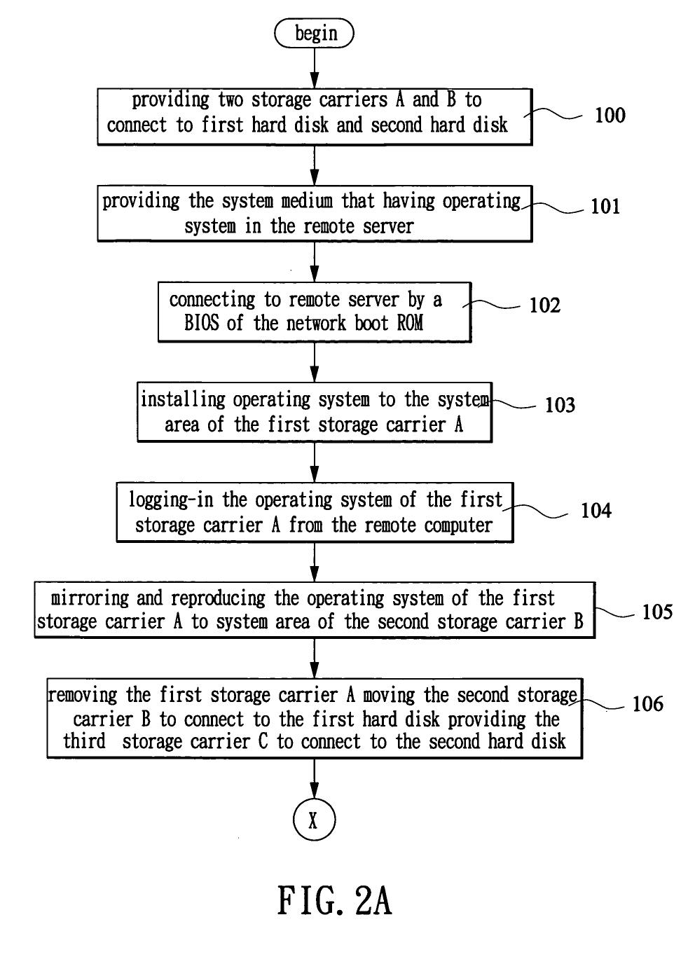

FIG. 1 shows a block diagram of the networked attached storage (NAS) according to the present invention and FIGS. 2A-B are a flowchart of the method according to the present invention. In general, there are many even-number storage devices in the networked attached storage (NAS) 10 such as the Hard Disk with SCISIC or IDE interface. The storage devices constitute a Redundant Array of Independent Disks (RAID). Preferably, four, eight, or sixteen hard disks of the same capacity are provided in a RAID system. The method of the present of the invention is exemplified with four hard disks.

The networked attached storage (NAS) of the present of the invention is connected to a remote sever 21 through a network 20 such as a local area network (LAN) or an Internet. The remote server 21, for example, can be Windows XP, Windows 2000 Server, Windows 2000 Professional, Windows 2003 Server or another compatible system. Moreover, a plurality of remote computers 22 is also connected to the remote server 21 through the network 20. Moreover the networked attached storage (NAS) 10 comprises at least a first hard disk 11, a second hard disk 12, a third hard disk 13, a fourth hard disk 14 and a BIOS 15 with a network boot ROM.

The method of the present of the invention comprises the following steps. In step 100, two external storage carriers A and B are provided and can be the same hard disks described above. The storage carriers A and B function as the first hard disk 11 and the second hard disk 12, and are connected to the interfaces of the first hard disk 11 and the second hard disk 12, respectively.

In step 101, a system medium 40 with a built-in operating system is provided in the remote server 21 connected to the network 20. The system medium 40 can be a CD-ROM drive for accessing an optical disk of DVD or CD format. Moreover the operating system managing the data access of the networked attached storage can be Windows, LINUX, UNIX or Netware.

Then, in step 102, an account/password of a default user and a default IP address are added to the remote server 21. The system medium 40 is set to be accessible by the default user. Then NAS is turned on and establishes network connection to the remote server 21 by starting the network with the BIOS having network boot ROM. The remote server 21 is logged in by the account/password of the default user and the default IP address.

After the remote server 21 is successfully logged in, the remote server 21 partitions the first storage carrier A into a system area and a data area automatically and formats the system area in step 102. Then the operating system of the system medium 40 is loaded to the system area of the first storage carrier A so as to be a fixed hard disk of the spare system in step 103.

Then, in step 104, a remote computer 22 connected to the network 20 is turned on and logged into the operating system of the first storage carrier A by using a browser such as IE and typing default IP address and communication port.

Afterward, a predetermined mirror service is activated to execute automatically the partitioning of the second storage carrier B into a system area and a data area. The system area is then formatted.

In step 105, the operating system in the first storage carrier A is mirrored to the system area of the second storage carrier B. After finishing the above action, a buzzer beeps twice to inform the user that the operation is finished.

In step 106, the NAS is powered off and the first storage carrier A is removed. The second storage carrier B is connected to the first hard disk, and the third storage carrier C is connected to the second hard disk The networked attached storage (NAS) is then turned on.

Similarly, in step 107, the mirror service is activated to execute automatically partitioning of the third storage carrier C for a system area and a data area. The system area is then formatted. Moreover, the operating system in the first hard disk 11 (the second storage carrier B) is mirrored to the system area of the second hard disk 12 (the third storage carrier C).

Afterward, in step 108, a copying procedure is executed to initialize automatically partitioning of the third hard disk 13 and the forth hard disk 14. The third and forth hard disks are partitioned into a system area and a data area, respectively. The operating system of the first hard disk 11 is then mirrored to the system area of disks 13 and 14. The disks 13 and 14 are then set to be a restoring mirror source for the first and second disks 11 and 12. Afterward, the buzzer beeps three times to inform the user.

Finally, in step 109, a RAID service routine is executed to format evenly the data area of the first to fourth disks. The data area can thus be the RAID of the even number hard disks. The buzzer then beeps four times to inform the user.

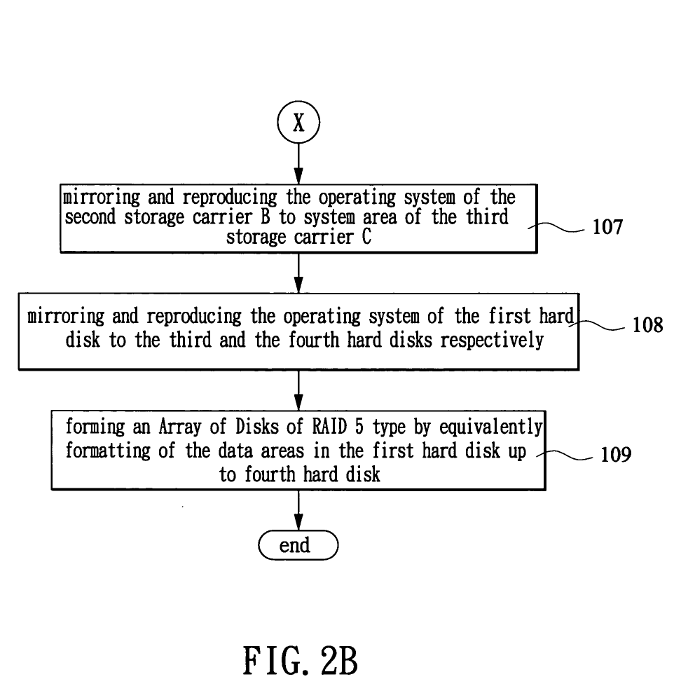

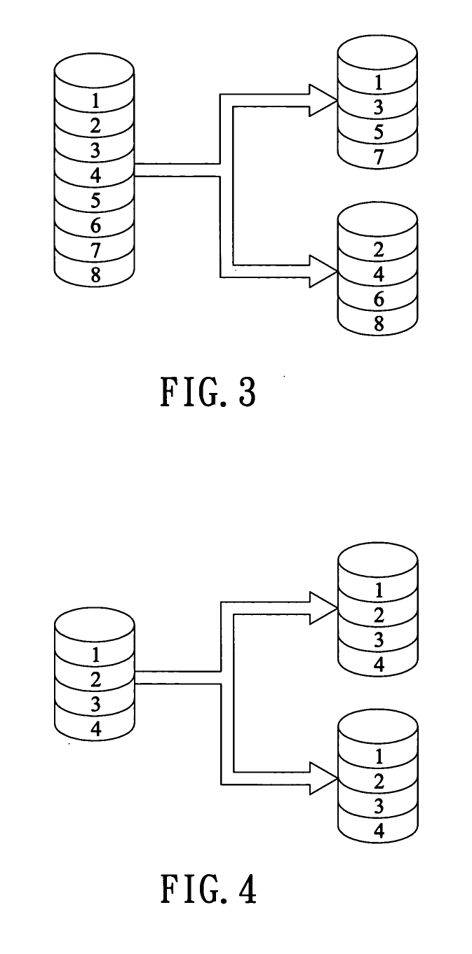

The RAID of the even number hard disks of the networked attached storage 10 of the present invention functions as the parallel storage of the RAID to enhance the efficacy of the storage such as in FIG. 3, a schematic diagram of the paralleling storage of a RAID, and functions as the mirroring storage of the RAID to increase the security and the fault tolerance of the data of storage such as in FIG. 4, a schematic diagram of the mirroring storage of a RAID. Moreover, the present invention can be of RAID LEVEL 5 format by integrating the frames of the parallel storage and the mirroring storage, and dispersing the parity in some or all storage devices.

Although the present invention has been described with reference to the preferred embodiment thereof, it will be understood that the invention is not limited to the details thereof. Various substitutions and modification have suggested in the foregoing description, and other will occur to those of ordinary skill in the art.

Therefore, all such substitutions and modifications are intended to be embraced within the scope of the invention as defined in the appended claims.

1. A method for installing a networked attached storage, said storage being connected to a network, and including at least a first, a second, a third and a fourth storage devices, the method comprising the steps of:
providing a first and second storage carriers to connect to said first storage device and said second storage device, respectively;
providing a system medium with a built-in operating system, and set in a remote server connected to said network;
installing said operating system in a system area of the first storage carrier;
mirroring said operating system to a system area of the second storage carrier; and
mirroring said operating system to a system area of the third and a system area of the fourth storage device, respectively.

2. The method for installing networked attached storage as in claim 1, wherein there are even storage devices set in said storage for setting a Redundant Array of Independent Disks.

3. The method for installing networked attached storage as in claim 1, wherein said storage device is a SCSI hard disk or a IDE hard disk.

4. The method for installing networked attached storage as in claim 1, wherein said network is a local area network or an Internet.

5. The method for installing networked attached storage as in claim 1, wherein said first storage carrier and second storage carrier are identical to said storage device.

6. The method for installing networked attached storage as in claim 1, wherein said system medium is a CD-ROM drive for accessing an optical disk of DVD format or CD format.

7. The method for installing networked attached storage as in claim 1, wherein said operating system is Windows, LINUX, UNIX or Netware.

8. The method for installing networked attached storage as in claim 1, wherein said remote server is a Windows Server or a compatible server.

9. The method for installing networked attached storage as in claim 1, further comprising a step of adding an account/password of a default user and a default IP address to the remote server, and setting the system medium to be accessible to the default user.

10. The method for installing networked attached storage as in claim 1, further comprising:
providing a BIOS with network boot ROM in the storage device and turning on the NAS to establish connection between the NAS and the remote server through operating said BIOS.

11. The method for installing networked attached storage as in claim 1, further comprising:
partitioning said first storage carrier into a system area and a data area, and formatting said system area.

12. The method for installing networked attached storage as in claim 1, further comprising:
logging into the operating system of said first storage carrier through a remote computer connected to the network.

13. The method for installing networked attached storage as in claim 1, wherein said storage carrier is a spare Fixed Hard Disk.

14. The method for installing networked attached storage as in claim 1, further comprising:
partitioning said second storage carrier into a system area and a data area, and formatting said system area.

15. The method for installing networked attached storage as in claim 1, further comprising:
removing said first storage carrier;
connecting said second storage carrier to said first storage carrier;
providing a third storage carrier and connecting to said second storage device; and
mirroring said operating system to the system area of said second storage device.

16. The method for installing networked attached storage as in claim 15, further comprising:
turning off said networked attached storage before removing said first storage carrier.

17. The method for installing networked attached storage as in claim 15, further comprising:
turning on said networked attached storage before mirroring said operating system.

18. The method for installing networked attached storage as in claim 15, further comprising:
partitioning said third storage carrier to form a system area and a data area and formatting said system area.

19. The method for installing networked attached storage as in claim 15, further comprising:
partitioning said third storage device and fourth storage device to form a system area and a data area.

20. The method for installing networked attached storage as in claim 1, further comprising:
setting said third and fourth storage devices to be a mirroring source for restoring the first storage device.

21. The method for installing networked attached storage as in claim 1, further comprising:
formatting equivalently all the data areas of said storage devices to form a redundant array of independent disks (RAID).

22. The method for installing networked attached storage as in claim 21, wherein said storage device is of even amount and used to be paralleling storage of said redundant array of independent disks (RAID) to enhance efficacy of the storage.

23. The method for installing networked attached storage as in claim 21, wherein said storage device is of even amount and used to be mirroring storage of said redundant array of independent disks (RAID) to increase security and fault tolerance of the data in the storage.

24. The method for installing networked attached storage as in claim 21, wherein said redundant array of independent disks is a RAID Level 5 format by a distributed parity check in some or all storage devices.
